(19) United States
(12) Patent Application Publication
(10) Pub. No.: US 2012/0215552 A1
(43) Pub. Date: Aug. 23, 2012

(54) SYSTEMS, METHODS, AND MEDIUMS TO PROVIDE CENTRALIZED ACCESS TO HEALTHCARE INFORMATION

(76) Inventor: Mathilde Goldschmidt, Portland, OR (US)

(21) Appl. No.: 13/341,548

(22) Filed: Dec. 30, 2011

Related U.S. Application Data
(60) Provisional application No. 61/444,528, filed on Feb. 18, 2011.

(51) Int. Cl. G06Q 10/10; G06Q 50/22

(52) U.S. Cl. 705/2; 705/7.12

(57) ABSTRACT

The present disclosure describes systems, methods, and mediums to provide centralized access to healthcare information by displaying a page including a plurality of prompts corresponding to a plurality of actions associated with a patient, by receiving a selection of at least one of the plurality of prompts corresponding to at least one of the plurality of actions, displaying of an action page including a plurality of data entry fields corresponding to the at least one of the plurality of actions in response to the selection, and by receiving response data to at least one of the plurality of data entry fields, wherein the plurality of actions includes transmitting a notification that includes a wait time associated with the appointment, remotely checking-in for an appointment, saving an audio recording of the appointment, or reviewing an audio recording of the appointment.

### RELATED APPLICATIONS

This application is a non-provisional of pending U.S. provisional application Ser. No. 61/444,528, filed Feb. 18, 2011, all of which is incorporated herein in it's entirety.

### COPYRIGHT NOTICE

© 2010-2011 Mathilde Goldschmidt. The copyright owner has no objection to the facsimile reproduction by anyone of the patent document or the patent disclosure, as it appears on the U.S. Patent and Trademark Office patent file or records, but otherwise reserves all copyright rights whatsoever as permitted under 37 CFR §1.71(d).

### TECHNICAL FIELD

The present disclosure is related to systems, methods, and mediums to provide centralized access to healthcare information and improve patients' interaction with their healthcare.

### BACKGROUND

Healthcare providers such as hospitals or clinics use computerized information systems to manage medical, administrative, financial, and/or laboratory data. These known information systems are often not cohesive meaning that the information system managing medical data is distinct from the information system set up to manage administrative or financial data. Often, these known information systems are not coded to share data with varying healthcare providers and facilities. These known information systems are not seamless in that only certain kinds of data is passed from one system to another. These known information systems are often owned by and designed for the benefit of doctors, hospitals or clinics, not patients. As a result, a patient only has access to data, including portions of their personal medical records or medical history, as determined by the doctors, hospitals, or clinics. If a healthcare provider practices at different facilities or hospitals, the provider often cannot seamlessly access systems managed by each of the different facilities or hospitals. Absent executed formal consent documents, a patient is not likely to ever be able to review complete personal medical data for reasons having little to do with the patient's treatment or care: a patient's access to personal medical data may be curtailed for reasons of medical liability. Another result is that even if a patient has access to the medical data, the information system is likely to present the data in a manner that is not conducive to having the patient understand his or her medical situation. Rather, the information system presents data to facilitate a doctor's diagnosis or orders.

Another disadvantage is the inability of a patient to schedule their own appointments, find their own doctors, communicate directly with medical personnel, and other such functions in an environment that is accessible any time of the day on any day of the week and which avoids the need to interact with live personnel to find suitable dates and times. This and other disadvantages adversely may affect the quality of the resulting medical care and the overall experience of the patient with the medical professionals rendering such medical care.

### BRIEF DRAWINGS DESCRIPTION

FIG. 1 depicts an illustration of an exemplary system incorporating systems, methods, and mediums to provide centralized access to healthcare information.

FIG. 2A depicts an illustration of an exemplary computing device 102 incorporating systems, methods, and mediums to provide centralized access to healthcare information.

FIG. 2B depicts an illustration of a home page 250 associated with an exemplary graphical user interface of the system 100.

FIG. 3A depicts a flowchart for an exemplary method 300 associated with the appointments module 202.

FIG. 3B depicts an illustration of an appointment page 350 associated with appointments module 202.

FIG. 4 depicts an illustration of exemplary capabilities associated with the check-in module 204.

FIG. 5A depicts a flowchart for an exemplary method 500 associated with the notifications module 206.

FIG. 5B depicts an illustration of a notification 550 associated with notifications module 206.

FIG. 6 depicts a flowchart for an exemplary method 600 associated with the audio/video module 208.

FIG. 7 depicts a flowchart for an exemplary method 700 associated with the forms module 210.

FIG. 8 depicts an illustration of exemplary capabilities associated with the prescriptions module 212.

FIG. 9 depicts an illustration of exemplary capabilities associated with the financials module 214.

FIG. 10 depicts an illustration of exemplary capabilities associated with the tests module 216.

FIG. 11 depicts an illustration of exemplary capabilities associated with the progress module 218.

FIG. 12 depicts an illustration of exemplary capabilities associated with the profile module 220.

FIG. 13 depicts an illustration of exemplary capabilities associated with the mobile application module 222.

### DETAILED DESCRIPTION

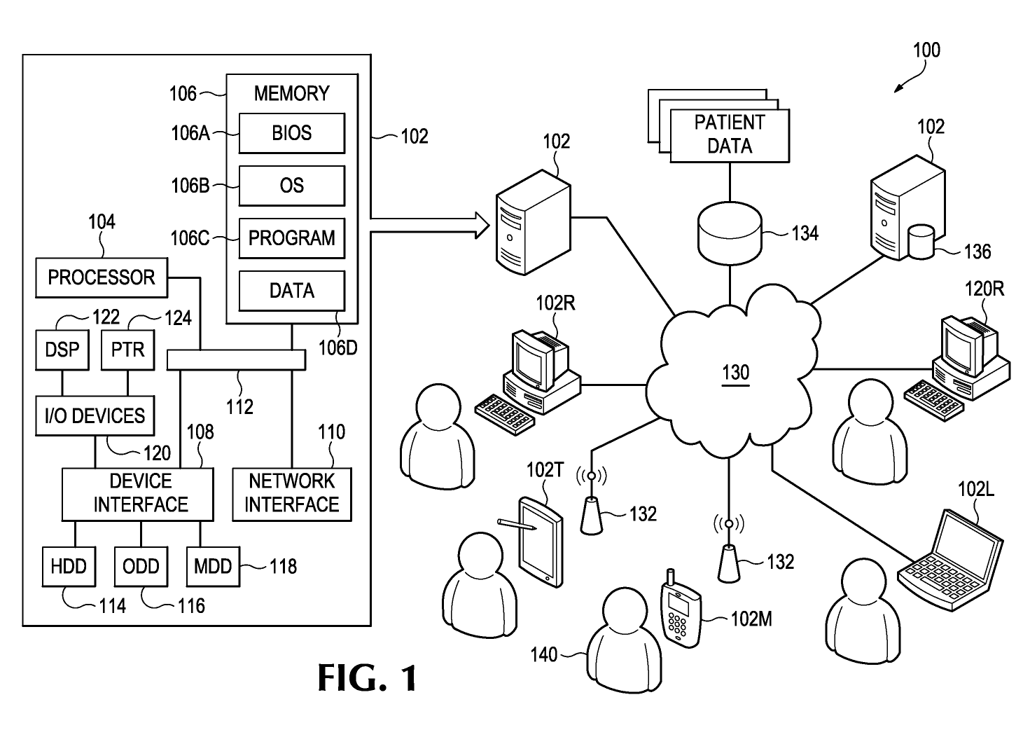

FIG. 1 depicts an illustration of an exemplary system incorporating systems, methods, and mediums to provide centralized access to healthcare information. Referring to FIG. 1, a system 100 includes a computing device 102 that executes one or more instructions of one or more application programs or modules stored in system memory, e.g., memory 106. The application programs or modules may include routines, programs, objects, components, data structures, and like that perform particular tasks or implement particular abstract data types. A person of ordinary skill in the art will recognize that many of the concepts associated with the systems and methods to provide centralized healthcare information, may be instantiated or implemented as computer instructions, firmware, or software in any of a variety of computing architectures, e.g., computing device 102, to achieve the same or equivalent result.

Moreover, a person of ordinary skill in the art will recognize that the systems and methods to provide centralized healthcare information may be implemented on other types of computing architectures, e.g., general purpose or personal computers, hand-held devices, multi-processor systems, microprocessor-based or programmable consumer electronics, minicomputers, mainframe computers, application specific integrated circuits, and like. For illustrative purposes only, system 100 is shown in FIG. 1 to include a computing devices 102, geographically remote computing devices 102R, tablet computing device 102T, mobile computing device 102M, and laptop computing device 102L.

Similarly, a person of ordinary skill in the art will recognize that the systems and methods to provide centralized healthcare information may be implemented in a distributed computing system in which various computing entities or devices, often geographically remote from one another, e.g., computing device 102 and remote computing device 102R, perform particular tasks or execute particular instructions. For example, the systems and methods may be implemented in a server/client configuration (e.g., computing device 102 may operate as a server and remote computing device 102R may operate as a client). In distributed computing systems, application programs or modules may be stored in local memory 106, external memory 136, or remote memory 134. Local memory 106, external memory 136, or remote memory 134 may be any kind of memory known to a person of ordinary skill in the art.

The computing device 102 comprises a processing device 104, memory 106, device interface 108, and network interface 110, all interconnected through bus 112. The processing device 104 represents a single, central processing unit, or a plurality of processing units in a single or two or more computing devices 102, e.g., computing device 102 and remote computing device 102R. The local memory 106, as well as external memory 136 or remote memory 134, may be any type memory device including any combination of random access memory (RAM) or read only memory (ROM). The local memory 106 may include a basic input/output system (BIOS) 106A with routines to transfer data between the various elements of the computer system 100. The local memory 106 may also include an operating system (OS) 106B that, after being initially loaded by a boot program, manages all the other programs in the computing device 102. The local memory 106 may store other routines or programs, e.g., application programs 106C. The application programs 106C may make use of the OS 106B by making requests for services through a defined application program interface (API). The application programs 106C may include any program designed to perform a specific function directly for a user or, in some cases, for another application program. Examples of application programs include word processors, database programs, browsers, development tools, drawing, paint, and image editing programs, communication programs, specialized application programs as we describe in more detail below, and the like. Users may interact directly with the OS 106B through a user interface such as a command language or a graphical user interface (GUI) displayed on a monitor 122.

Device interface 108 may be any one of several types of interfaces. The device interface 108 may operatively couple any of a variety of devices, e.g., hard disk drive 114, optical disk drive 116, magnetic disk drive 118, or like, to the bus 112. The device interface 108 may represent either one interface or various distinct interfaces, each specially constructed to support the particular device that it interfaces to the bus 112. The device interface 108 may additionally interface input or output devices 120 utilized by a user to provide direction to the computing device 102 and to receive information from the computing device 102. These input or output devices 120 may include keyboards, monitors, mice, pointing devices, speakers, stylus, microphone, joystick, game pad, satellite dish, printer 124, scanner, camera, video equipment, modem, monitor, and like (not shown). The device interface 108 may be a serial interface, parallel port, game port, firewire port, universal serial bus, or the like.

The hard disk drive 114, optical disk drive 116, magnetic disk drive 118, printer 124, and monitor 122, or like may include memory 106 such as a computer readable medium that provides non-volatile storage of computer readable instructions of one or more application programs or modules 106C and their associated data structures. A person of skill in the art will recognize that the system 100 may use any type of computer readable medium accessible by a computer, such as magnetic cassettes, flash memory cards, digital video disks, cartridges, RAM, ROM, and the like.

Network interface 110 operatively couples the computing device 102 to one or more remote computing devices 102R, tablet computing devices 102T, mobile computing devices 102M, and laptop computing devices 102L, on a local or wide area network 130. The computing devices 102R may be geographically remote from computing device 102. The remote computing devices 102R may have the structure of computing device 102, or may be a server, client, router, switch, peer device, network node or other networked device and typically includes some or all of the elements of computing device 102. The computing device 102 may connect to the local or wide area network 130 through a network interface or adapter included in the interface 110. The computing device 102 may connect to the local or wide area network 130 through a modem or other communications device included in the network interface 110. The computing device 102 alternatively may connect to the local or wide area network 130 using a wireless device 132. The modem or communications device may establish communications to remote computing devices 102R through global communications network 130. A person of ordinary skill in the art will recognize that application programs or modules 106C might be stored remotely through such networked connections.

We may describe some portions of the systems, methods, and mediums to provide centralized access to healthcare information using algorithms and symbolic representations of operations on data bits within a memory, e.g., memory 106. A person of skill in the art will understand these algorithms and symbolic representations as most effectively conveying the substance of their work to others of skill in the art. An algorithm is a self-consistent sequence leading to a desired result. The sequence requires physical manipulations of physical quantities. Usually, but not necessarily, these quantities take the form of electrical or magnetic signals capable of being stored, transferred, combined, compared, and otherwise manipulated. For simplicity, we refer to these signals as bits, values, elements, symbols, characters, terms, numbers, or like. The terms are merely convenient labels. A person of skill in the art will recognize that terms such as computing, calculating, determining, displaying, or like refer to the actions and processes of a computing device, e.g., computing device 102. The computing device 102 may manipulate and transform data represented as physical electronic quantities within a memory into other data similarly represented as physical electronic quantities within the memory.

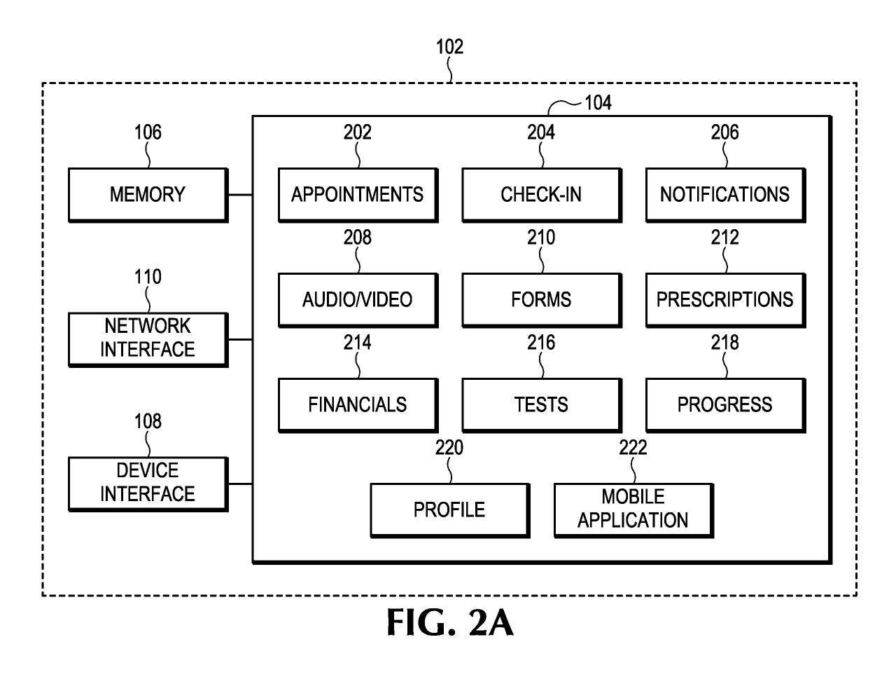

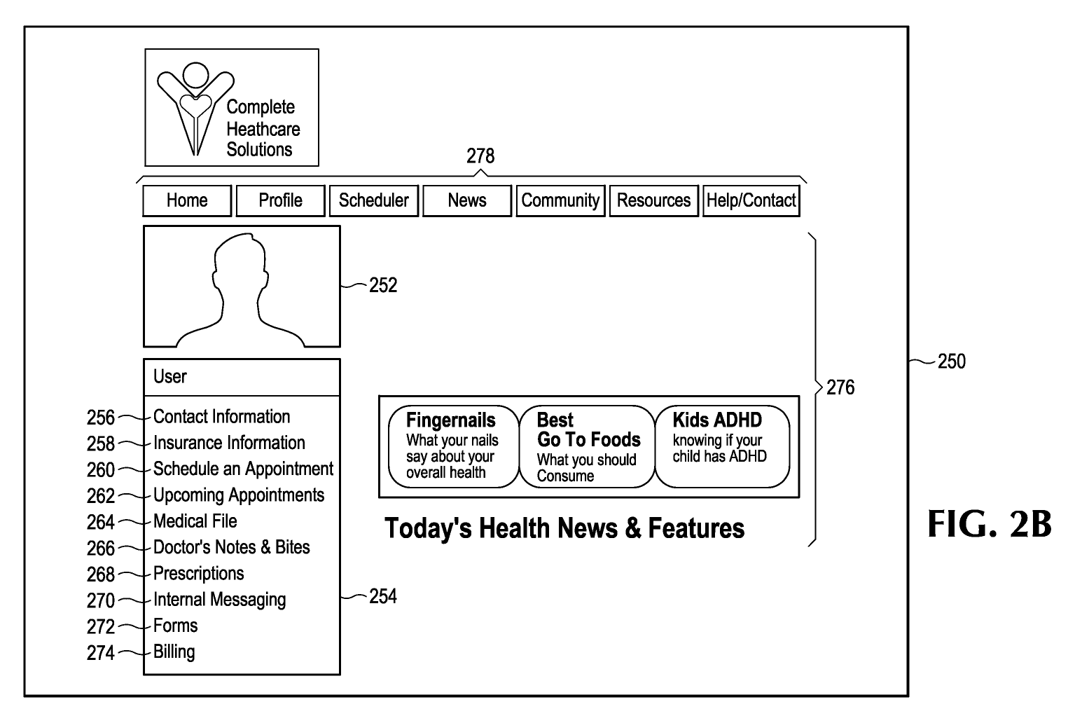

FIG. 2A depicts an illustration of an exemplary computing device 102 incorporating systems, methods, and mediums to provide centralized access to healthcare information. Referring to FIG. 2A, the computing device 102 includes a processing device 104 that may execute one or more instructions of one or more application programs or modules 106C stored in system memory 106 as we detail above. The processing device 104 may receive data from or transmit data to other computing devices 102 or application programs 106C through the network interface 110 or the device interface 108. The network interface 110 or the device interface 108 may include or work cooperatively with a graphical user interface (not shown) displayed on a monitor 122. The application programs 106C may use elements from the graphical user interface, e.g., menus, buttons, scroll bars, images, wizards, and the like, that are included with the operating system and add their own graphical user interface elements and ideas.

The processing device 104 may execute instructions stored in the memory 106 that are associated with the application programs 106C. The processing device 104 may execute instructions for a plurality of application programs 106C, including instructions associated with appointments module 202, check-in module 204, notifications module 206, audio/video module 208, forms module 210, prescriptions module 212, financials module 214, tests module 216, progress module 218, profile module 220, and mobile application module 222. These modules may include instructions that, when executed by the processing device 104, cause display of or operate cooperatively with the graphical user interface associated with the computing device 102. The graphical user interface is configured to graphically display information to and capture data from a user 140 (FIG. 1) that the interface provides to the processing device 104 executing the application programs or modules 106C.

FIG. 2B depicts an illustration of a home page 250 associated with an exemplary graphical user interface of the system 100. The home page 250 may have various sections or panels to display various aspects of the system 100. In particular, the home page 250 may include a user image panel 252 including an icon, an avatar, or a photograph of the user 140. A user information panel 254 identifies a name of the user 140, as well as other information or links pertinent to the user 140's medical care, e.g., contact information 256, insurance information 258, appointment scheduling information 260, upcoming appointments 262, medical record 264, doctor's notes and sound bites 266, prescriptions 268, internal messaging 270, forms 272, and billing 274. The user 140 may actuate any of the links on the information panel 254 to access pages specific to the actuated link as we describe in more detail below. The home page 250 may include other panels related to the user 140's medical, e.g., health information panel 276 that describes various health related issues. The home page 250 may further include a task bar 278 with links to the various panels pertinent to the user 140's medical care.

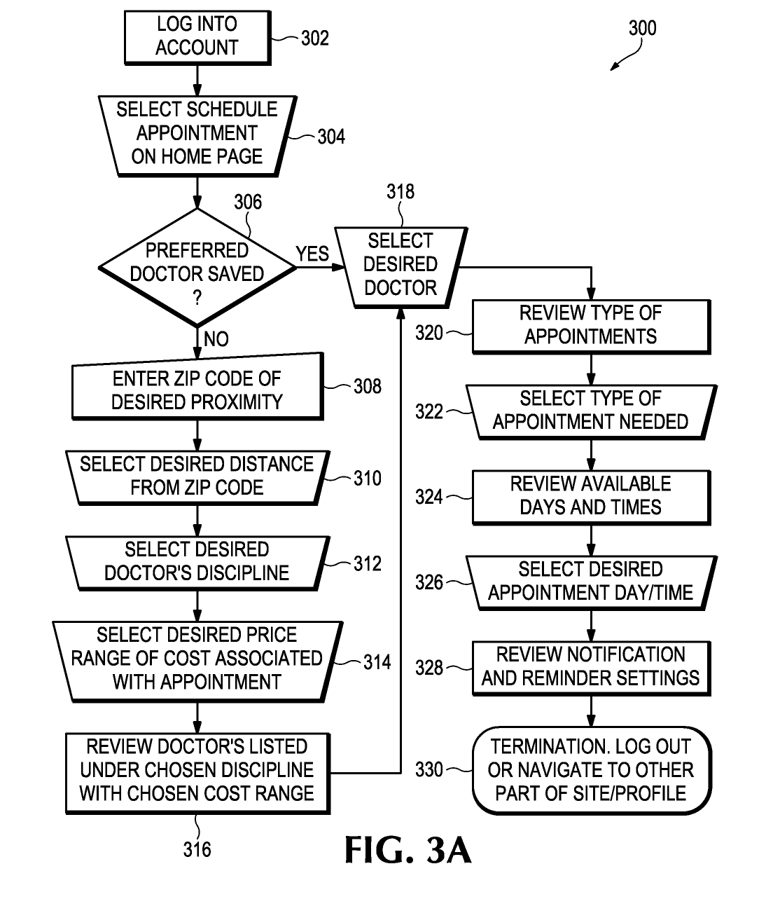

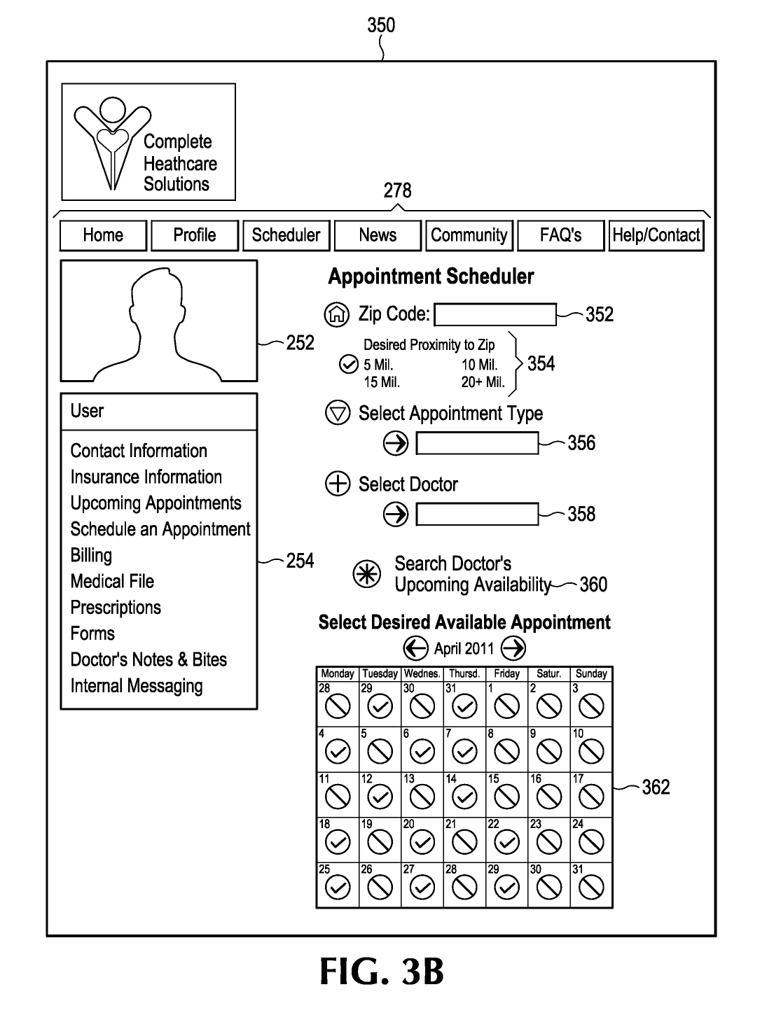

FIG. 3A depicts a flowchart for an exemplary method 300 associated with the appointments module 202. Referring to FIG. 3A, the user 140 may access a website associated with the appointments module 202 and log in to a user account at 302. The user 140 may select the scheduling page at 304 by any means known to a person of skill in the art, e.g., by actuating an associated link on the home page 250. The user 140 alternatively may select the scheduling page by selecting a choice from a pull down menu or click on a representative icon on home page 250. At 306, the method 300 may query the user 140 to determine whether the user 140 has previously saved a preferred medical provider. If so, the method 300 may query the user 140 for a zip code associated with a proximate geographic region in which the user 140 wants to schedule the appointment at 308 and may query the user 140 at 310 for a desired distance from the zip code to facilitate scheduling the appointment at a medical facility located nearby. At 314, the method 300 may query the user for a desired medical specialty and/or a cost or cost range associated with the appointment, e.g., in the case that the user 140 does not have medical insurance, desires the knowledge of specific costs incurred regardless of medical insurance coverage, or wishes to pay for the cost of the appointment with out of pocket money. At 316, the method 300 may display a list of doctors that meet the various criteria, i.e., geographic location as defined by the zip code, proximate distance, medical specialty, and cost. At 318, the method 300 may prompt the user 140 to select a medical provider from a list provided at 316. The method 300 may display user feedback or ratings associated with at least one of the medical providers on the list. The method 300 may display a network or group to which at least one of the medical providers in the list belongs. The method 300 may display a list of appointment types at 320 that are available for the particular medical provider chosen at 316 and may prompt the user 140 to select an appointment type at 322 from the list displayed at 320. The method 300 may present available appointments at 324 and may prompt the user 140 to select the desired appointment type at 326. The method 300 immediately may send, via email, text, or other known means, a notification to the user 140 at 328 indicating details associated with the appointment. The method 300 may additionally allow the user 140 to set reminders at a preferred frequency, time of day, days before appointment, and the like at 328. The method 300 may send out the reminder notifications to the user in advance of the appointment. The reminder notifications may be sent out in any manner known to a person of reasonable skill in the art, including email, text, voicemail, and the like. The method 300 may transmit an electronic reminder file capable of being incorporated into calendaring applications such as Outlook (e.g., an Outlook appointment).

FIG. 3B depicts an illustration of an appointment page 350 associated with appointments module 220. Referring to FIG. 3B, the appointment page 350 includes the user image panel 252, the user information panel 254, or the task bar 278 that we describe above in relation to FIG. 2B. The appointment page 350 may also include a zip code field 352 associated with a geographic region in which the user 140 wants to schedule the appointment and a proximity field 354 to enable the user 140 to specify the desired distance from the zip code to facilitate scheduling the appointment at a medical facility located nearby. The appointment page 350 may further include an appointment type field 356 configured to enable the user 140 to enter an appointment type and a doctor field 358 configured to enable the user 140 to enter a specific doctor's name or a medical specialty. The appointment page 350 may still further include other fields, e.g., a cost field (not shown) to enable display of a cost associated with the appointment. The appointment page 350 may include a search activation button or link 360 and a calendar 362 to display the availability of appointments that meet the particular search criteria entered by the user 140.

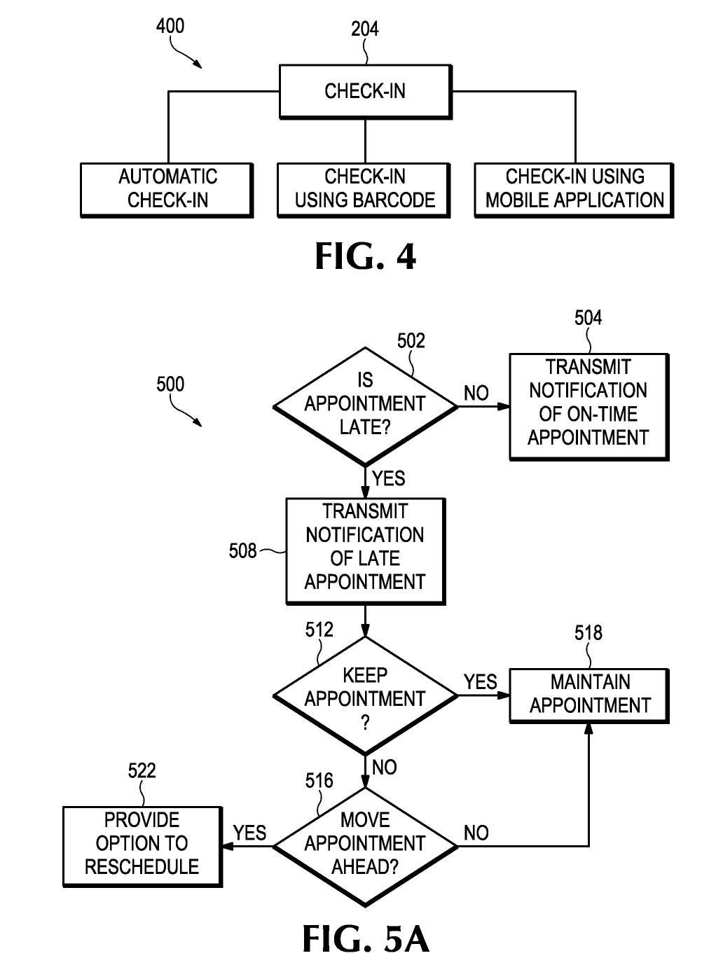

FIG. 4 depicts an illustration of exemplary capabilities associated with the check-in module 204. Referring to FIG. 4, the check-in module 204 may allow the user 140 to automatically check-in for a medical appointment using, e.g., an application program 106C. In one example, the check-in module 204 may allow the user 140 to set up and enable the use of the mobile computing device 102M to automatically check-in at 402. In one example, the user 140 may enable the mobile computing device 102M at 406 to transmit a check-in signal to the processing device 104 that, in turn, automatically checks-in the user 140 for the scheduled appointment. The mobile computing device 102M may transmit the check-in signal to the processing device 104 when the user 140 is within a predetermined distance from the location of the medical facility in which the appointment is scheduled, e.g., upon arrival to the parking lot of the medical facility. The mobile computing device 102M may transmit the check-in signal using known transmission means, including wireless, WiFi, and the like. The user 140 may alternatively check-in for the appointment using an application program 106C operating on the mobile computing device 102M in response to manual instructions or actions from the user 140. The user 140 may alternatively check-in for the appointment by scanning a bar code at 404 either displayed on the mobile computing device 102M or printed on a sheet of paper using a bar code reader available at the medical facility. In an embodiment, the check-in module 204 accelerates a speed at which a patient will be seen at a medical facility by associating a patient's medical information with the mobile computing device 102M, e.g., with a bar code displayed on the display of the mobile computing device 102M that is read at any particular station in the facility or by accepting a signal from the mobile computing device 102M when the patient's comes within a predetermined distance of the medical facility. In another embodiment, the medical provider may monitor information received from the mobile computing device 102M regarding the patient, e.g., a wireless weight scale, a wireless blood pressure monitor, and a wireless thermometer associated with the mobile computing device 102M may transmit information regarding the patient's weight fluctuations, blood pressure, and temperature, respectively, to the provider via the facility's system. If these devices are provided by the facility, the patient can then take their vitals and have their chart updated with their current vitals as they wait to be seen. In an embodiment, the check-in module 204 may include an ability to upload such information to the medical facility's system. The mobile computing device 102M may communicate with the facility's system to automatically update the patient's profile.

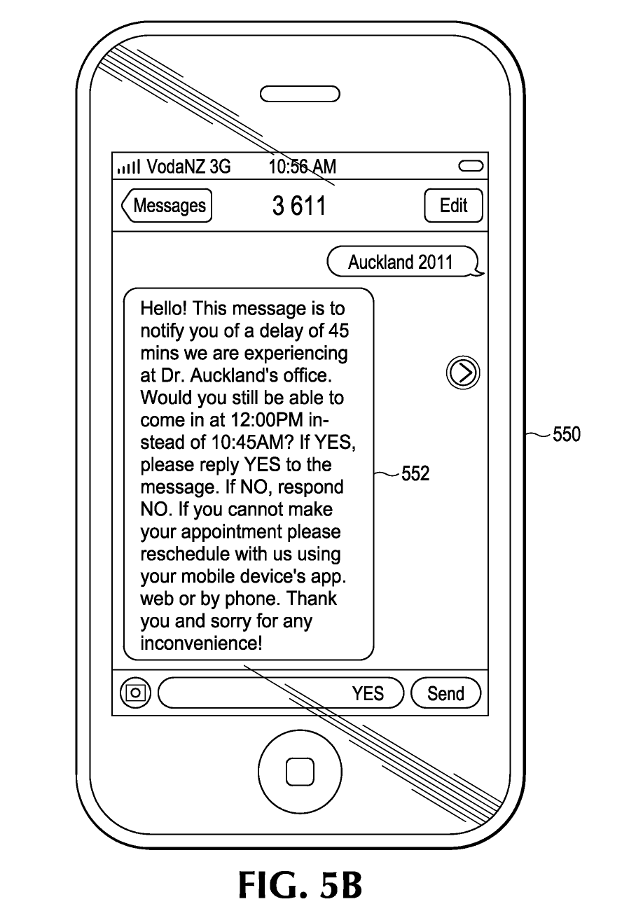

FIG. 5A depicts a flowchart for an exemplary method 500 associated with the notifications module 206. Referring to FIG. 5, the notifications module 206 may determine the timeliness of the scheduled appointment at 502. The notifications module 206 may automatically determine the scheduled appointment late by analyzing the timeliness of completed appointments at predetermined scheduled periods during the day. The notifications module 206 may alternatively determine the scheduled appointment late in response to an entry by, e.g., a receptionist or a medical assistant at the medical facility, that indicates the expected delay based on experience with the circumstances that have developed or are present at any given time, e.g., patient emergencies or doctor's availability. If the appointment is on time as determined at 502, the notifications module 206 may so notify the user 140 at 504. The notifications module 206 may notify the user 140 of the timeliness of the scheduled appointment time by any known means, e.g., text message to the mobile computing device 102M or the tablet computing device 102T, email message, pre-recorded voice message, automated phone call, and the like. The notifications module 206 may notify the user 140 that the appointment is on-time responsive to a wait time being less than a predetermined time, e.g., 10 minutes, from the scheduled appointment time.

In response to a determination that the scheduled appointment is late at 502, the notifications module 206 may so notify the user 140 at 508. The notifications module 206 may determine that the appointment is delayed in response to a wait time being greater than the predetermined time, e.g., 10 minutes, from the scheduled appointment time. If the appointment is delayed, the processing device 104 may determine whether the user 140 wants to keep the scheduled appointment at 512. If so, the notifications module 206 may allow the user 140 to maintain the appointment at 518. If not, the notifications module 206 may provide the user 140 the option of rescheduling or canceling the appointment at 522 by, e.g., notifying the user 140 of such options and directing the user 140 to log on to the user account to make the desired changes.

In response to a determination that the scheduled appointment is late at 502, notifications module 206 may query the user 140 at 516 to determine whether the user 140 wishes to see the medical provider at an earlier time, in response to the computing device 102 determining that such an option exists. The processing device 104 may allow the user 140 to maintain the appointment or move the appointment up to an earlier time at 522 by, e.g., notifying the user 140 of such options at 522, directing the user 140 to log on to the user account to make the desired appointment changes, or, alternatively, automatically redirecting the computing device 102 to the appointments module 202.

FIG. 5B depicts an illustration of a notification 550 associated with notifications module 206. The notification 550 is shown displayed as a text message 552 sent by the system 100 to a mobile computing device 102M.

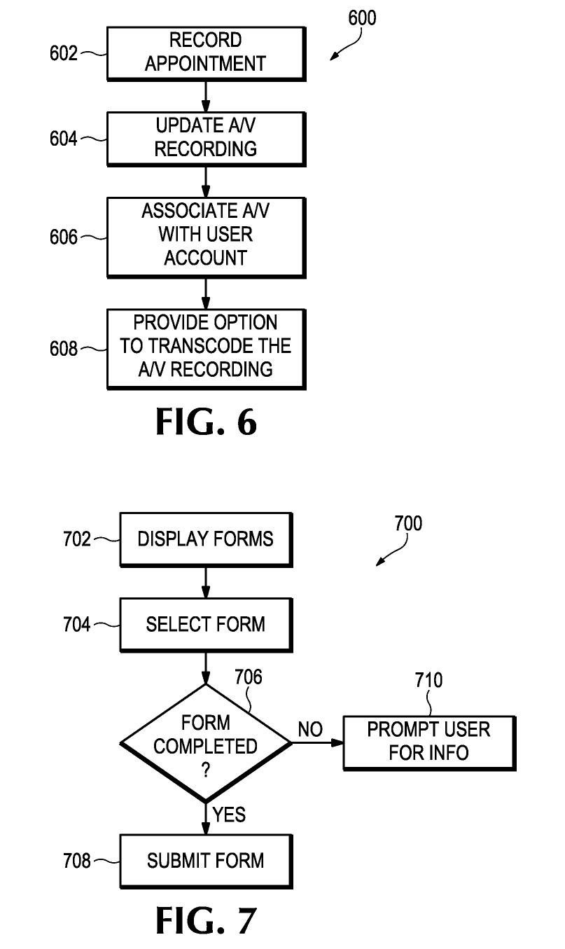

FIG. 6 depicts a flowchart for an exemplary method 600 associated with the audio/video module 208. Referring to FIG. 6, the audio/video module 208 may record audio or video associated with an appointment at 602. The audio/video module 208 may record audio or video associated with the appointment using any means known to a person of skill in the art, e.g., using audio/video equipment installed in the examination room or using such capabilities in a mobile computing device 102M brought into the examination room by the user 140. The audio/video module 208 may record audio and video associated with the appointment onto any storage medium, e.g., memory 106, using any format known to a person of skill in the art. For example, the audio/video module 208 may record audio associated with the appointment to the memory 106 of the mobile computing device 102M as an MP3 audio file.

The audio/video module 208 may upload to the remote memory 134 (FIG. 1) for later access and review by the user 140 at 604. The audio/video module 208 may also associate the recorded audio or video with an account of the user 140 at 606. At 608, the audio/video module 208 may transcribe the recorded audio using any means known to a person of skill in the art, e.g., using automated transcription software.

FIG. 7 depicts a flowchart for an exemplary method 700 associated with the forms module 210. Referring to FIG. 7, the forms module 210 may make all type of forms necessary for the provision of medical care available to the user 140. The forms may include patient information forms, medical condition information, patient financial forms, medical insurance forms, medical record sharing consent forms, living wills, end of life directives, and the like. The forms module 210 may make the forms available to the user 140 by initially displaying the types of available forms on a monitor at 702. The user 140 may select one of the forms on the list at 704 by clicking on the name, icon, or other graphical representation associated with the particular form of interest. The forms module 210 may determine if the form requires information from the user 140 at 706 and, if so, the forms module 210 may prompt the user for the information at 710. The forms module 210 may determine that the form is filled out or that the form does not require further information from the user 140 at 706, and, if so, the forms module 210 may prompt the user 140 to submit the form to the computing device 102 for storage in a memory 106 at 708.

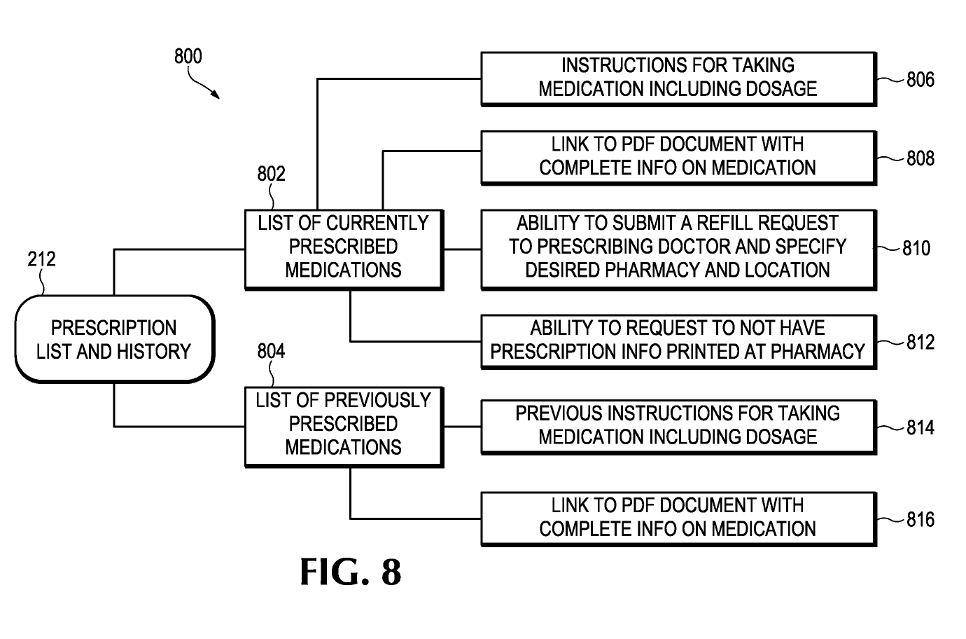

FIG. 8 depicts an illustration of exemplary capabilities associated with the prescriptions module 212. Referring to FIG. 8, the prescriptions module 212 may keep a list of currently prescribed medications for the user 140 at 802. For each of the listed currently prescribed medications, the prescriptions module 212, at 806, may include instructions for taking the medication, e.g., dosage. The prescriptions module 212 may include a link to a document, file, or page with complete information about the currently prescribed medication at 808. The prescriptions module 212, at 810, may also facilitate submission of a refill request for one or more of the listed medications. For example, the prescriptions module 212 may display a form fillable by the user 140 to request a refill of a particular medication at a particular pharmacy or location. In an embodiment, a patient may have the option to scan a bar code on their medication or manually enter the prescription number to update their chart or to request a prescription refill. The prescriptions module 212 may allow the user 140 at 812 to indicate that information associated with the medication not be printed at the pharmacy on pick up. Any number of pharmacies may be linked to prescriptions module 212. If a prescription is refillable, the user could click on their prescription they would like to refill and have it refilled to their preferred pharmacy automatically. The collaboration with various pharmacies would enable the user, doctor, and pharmacy to be in full streamlined communication. The pharmacies that collaborate with the system will facilitate the prescription process and earn retention from customers.

The prescriptions module 212 may also keep a list of previously prescribed medications at 804. For each of the listed previously prescribed medications, at 814, the prescriptions module 212 may include the instructions previously given for taking the medication, e.g., dosage. The prescriptions module 212 may include a link to a document, file, or page with complete information about the previously prescribed medication at 816. In an embodiment, the prescriptions module 212 may provide for alerts or notifications to the user of when to take a certain medication or when the prescription is running low in response to the dosage prescribed by the doctor. These alerts or notifications may take the form of email, text message, automated voicemail, and the like and occur at a predetermined time before the prescription runs out as set by the user. The prescriptions module 212 may direct the user to a location on the module where the user may request a refill, which, in turn, automatically forwards the refill request to the prescribing doctor or pharmacy or both. The prescriptions module 212 may transmit a notification to the user or patient indicating the availability of the prescription for pick up.

In an embodiment, the prescriptions module 212 may send prescription notifications via email to the user. Such an email may include a link to enable automatically submitting a refill request to the user's pharmacy of choice. In another embodiment, the prescriptions module 212 may send prescription notifications through text message in which a “no” reply will serve to indicate that the user does not wish to submit a refill request and a “yes” reply will serve to automatically transfer the refill request to the user's pharmacy of choice. In yet another embodiment, the prescriptions module 212 may send prescription notifications through automated voicemail message. In such a case, the prescriptions module 212 may prompt the user for information associated with the refill request through an automated system, e.g., “press 1 if you would like to send a refill request to your doctor, press 2 for other prescriptions questions”. The prescriptions module 212 may then automatically transmit the refill request to the prescribing doctor who may then transmit the refill to the user's pharmacy of choice, in response to the doctor's refill approval.

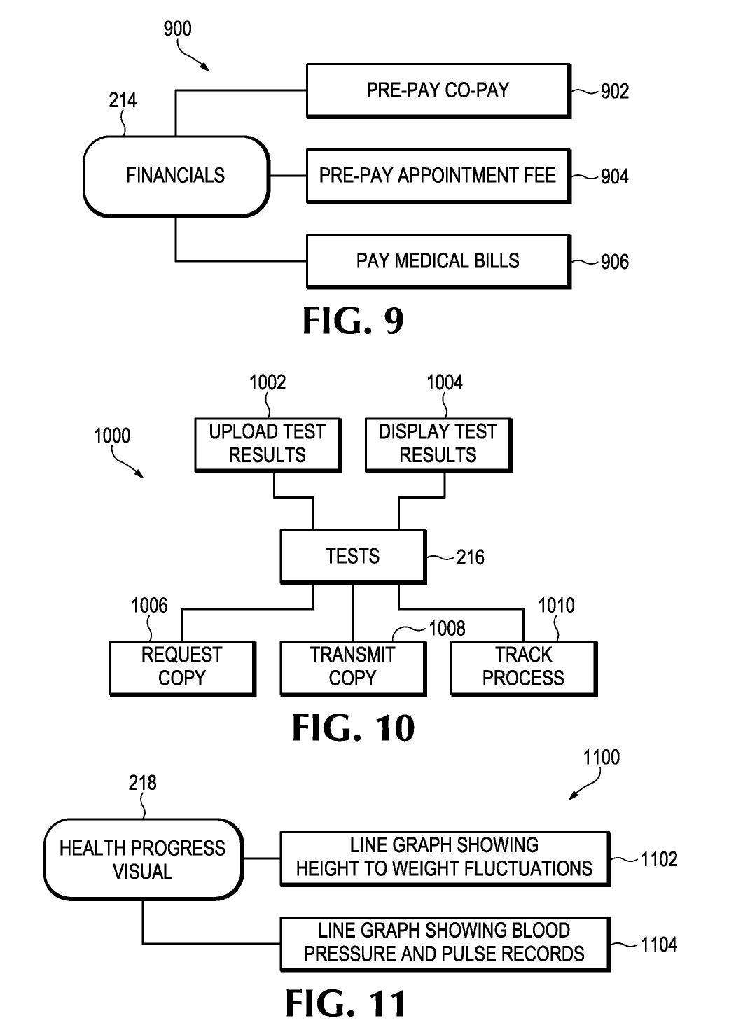

FIG. 9 depicts an illustration of exemplary capabilities associated with the financials module 214. Referring to FIG. 9, the financials module 214 may enable the user 140 to make any number of payments associated with medical services. The financials module 214 may enable the user 140 to pre-pay a co-payment at 902, to pre-pay an appointment fee at 904, or to review and pay medical bills at 906. The financials module 214 may enable the user to make the payments using any number of electronic or other known payment mechanisms, such as by entering a credit or debit card, by accessing the user 140's PayPal account, by accessing Google Easy Checkout, using electronic checks, or the like.

FIG. 10 depicts an illustration of exemplary capabilities associated with the tests module 216. Referring to FIG. 10, the tests module 216 may display information about any tests associated with the user 140. The tests module 216 may display tests ordered for the user 140, tests scheduled to be taken by the user 140, or tests performed on the user 140, and their associated results. At 1002, the tests module 216 may enable a testing entity performing the test to upload and record the test results to the user 140's account for easy retrieval by the user 140. At 1004, the tests module 216 may display the test results. The tests module 216 may display all kinds of test results in any form known to a person of skill in the art including using numbers, texts, 2- or 3-dimensional graphical representations, and the like. The tests module 216 may display imaging tests such as x-rays, CAT scans, magnetic resonance scans, and the like. The tests module 216 may enable the user 140 to request printed a printed copy of the test results at 1006. The printed copy of the test results may be certified as a true copy by the testing entity. At 1008, the tests module 216 may provide the user 140 with the means to send a copy of the test results to others, e.g., a second doctor for a second opinion. The means to send the copy of the test results may include any means, electronic or otherwise, known to a person of skill in the art, e.g., email, fax, or the like. At 1010, the tests module 216 may provide the ability to track changes in results from one test to another using any of a variety of numerical or graphical means, including tables, graphs, and the like.

FIG. 11 depicts an illustration of exemplary capabilities associated with the progress module 218. Referring to FIG. 11, the progress module 218 may display progress associated with the user 140's medical care. The progress module 218 may display progress in any form known to a person of ordinary skill in the art including using numbers, texts, 2- or 3-dimensional graphical representations, and the like. In one example shown at 1102, the progress module 218 may display a line graph showing height to weight fluctuations that may be helpful to aid the medical provider or the user 140 to adjust medications or other regiments accordingly. In another example shown at 1104, the progress module may display a line graph showing blood pressure and pulse records over predetermined periods.

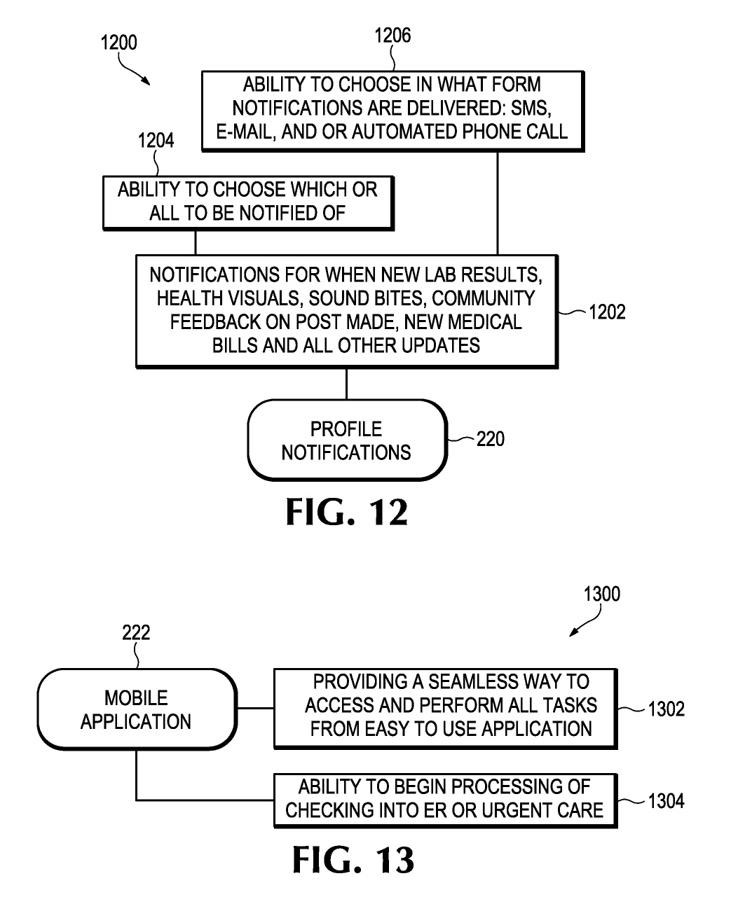

FIG. 12 depicts an illustration of exemplary capabilities associated with the profile module 220. Referring to FIG. 12, the profile module 220 may allow the user 140 to provide the system with contact information, notification preferences, and the like. In one example shown at 1202, the profile module 220 may allow the user 140 to set personal preferences regarding the types and frequency of notifications, e.g., new lab results, health visuals, sound bites, community feedback on posts made, new medical bills, and the like. The profile module 220 may provide the user with the ability to chose which notifications to receive (at 1204) and may provide the user 140 with the ability to chose the preferred type or means of notification, e.g., text message, email, automated phone call, and the like (at 1206). The profile module 220 may enable the identification of the user in case of an emergency or in case the user is rendered unconscious by linking, e.g., an identification tag physically worn by or otherwise associated with the user, to the user's profile. The user's profile may include a list of prescribed medications, medical conditions, medical allergies, and the like.

In an embodiment, the user may have the option of allowing or enabling a third party to view his profile, in full or in part. The profile module 220 may enable the user to give the third party a separate login name and password to view the user's profile. The user may set options associated with the third party's access to his profile, including which information the third party may view. For example, the user may allow the third party to view only a list of prescriptions but not a list of medical conditions. Although parents or guardians have legal access to a minor or incapacitated person's medical information, the profile module 220 may limit that access once the minor reaches adulthood or once the incapacitated person is no longer incapacitated.

FIG. 13 depicts an illustration of exemplary capabilities associated with the mobile application module 222. Referring to FIG. 13, the mobile application module 222 may execute on the mobile computing device 102M to allow the user 140 mobile remote access to the system 100 at 1302. The mobile application module 222 may provide a seamless manner in which to access and execute application programs 106C, including the appointments module 202, check-in module 204, notifications module 206, audio/video module 208, forms module 210, prescription module 212, financials module 214, test module 216, progress module 218, profile module 220, and mobile application module 222. The mobile application module 222 may also provide the ability of the user to check-in automatically at 1304, as we describe in more detail above.

A person of ordinary skill in the art will recognize that the processing device 104 may execute one or more instructions of one or more application programs or modules 106C stored in system memory 106 to be a source for health news, medical and life tips, exercise tips and healthy nutritional tips for all ages. The user may be provided with access to resources to aid them in determining if their symptoms necessitate a doctor's visit. In an embodiment, these resources may be segmented by age. Medical resources for the home and the like would be easily attainable through the site. The centralized aspect of this system may provide opportunities for potential partnerships with various commercial entities, including other websites dedicated to providing patient resources, e.g., WebMD, medicinenet, and the like.

In an embodiment, the user may also be able to send a message or note to their provider through an internal message system (not shown). The message or note exchanged may be privileged and confidential. In an embodiment, the user may be billed for any such message or note in excess of a predetermined number of messages, e.g., ten, at the discretion of the medical provider and their associated team of nurses.

A person of ordinary skill in the art will recognize that they may make many changes to the details of the above-described embodiments without departing from the underlying principles.

1. A method, comprising:
causing, by a computing device, a display of a page including a plurality of prompts corresponding to a plurality of actions associated with a patient;
receiving, by the computing device, a selection of at least one of the plurality of prompts corresponding to at least one of the plurality of actions;
causing, by the computing device, a display of an action page including a plurality of data entry fields corresponding to the at least one of the plurality of actions in response to the selection; and
receiving, by the computing device, response data to at least one of the plurality of data entry fields;
wherein the plurality of actions includes transmitting a notification that includes a wait time associated with the appointment, remotely checking-in for an appointment, saving an audio recording of the appointment, or reviewing an audio recording of the appointment.

2. The method of claim 1, wherein transmitting the notification further comprises transmitting the notification to a mobile device as a text message, transmitting the notification to a phone as an automated voice message, or transmitting the notification through email.

3. The method of claim 2, wherein the transmitting the notification further comprises transmitting the notification to indicate that the appointment is on-time or delayed in response to the wait time.

4. The method of claim 3, wherein the text message includes information associated with rescheduling the appointment in response to the appointment being delayed.

5. The method of claim 3, wherein the text message indicates that the patient can be seen prior to the appointment.

6. The method of claim 1, further comprising
causing, by the computing device, a display of wait time associated with the appointment.

7. The method of claim 1, wherein remotely checking-in for the appointment further includes receiving instructions for remotely checking-in for the appointment from a mobile device.

8. The method of claim 7, wherein remotely checking-in for the appointment further includes receiving instructions for automatically checking-in in response to detecting the mobile device is located within a predetermined geographic area of a location associated with the appointment.

9. The method of claim 1, wherein saving the audio recording of the appointment further includes automatically transcribing the audio recording.

10. The method of claim 1, wherein reviewing the audio recording of the appointment further includes displaying, by the computing device, a link configured to activate playing of the audio recording.

11. The method of claim 1, wherein the plurality of actions further includes modifying a profile associated with the patient, reading lab or test results for the patient, viewing a graphical display of health progress for the patient, reviewing a list of prescriptions of the patient, ordering the prescriptions of the patient, making a payment associated with the appointment, scheduling an appointment for the patient, or accessing medical forms needed by the patient to track health.

12. An apparatus, comprising:
a memory device configured to store instructions; and
a processing device configured to execute the instructions stored in the memory device that cause the processing device to perform operations comprising:
causing, by a computing device, a display of a page including a plurality of prompts corresponding to a plurality of actions associated with a patient;
receiving, by the computing device, a selection of at least one of the plurality of prompts corresponding to at least one of the plurality of actions;
causing, by the computing device, a display of an action page including a plurality of data entry fields corresponding to the at least one of the plurality of actions in response to the selection; and
receiving, by the computing device, response data to at least one of the plurality of data entry fields;
wherein the plurality of actions includes transmitting a notification that includes a wait time associated with the appointment, remotely checking-in for an appointment, saving an audio recording of the appointment, or reviewing an audio recording of the appointment.

13. The apparatus of claim 12, wherein transmitting the notification further comprises transmitting the notification to a mobile device, transmitting the notification to a phone, or transmitting the notification through email.

14. The apparatus of claim 13, wherein the transmitting the notification further comprises sending a text message indicating that the appointment is on-time or delayed in response to the wait time.

15. The apparatus of claim 14, wherein the text message includes information associated with rescheduling the appointment in response to the appointment being delayed.

16. The apparatus of claim 14, wherein the text message indicates that the patient can be seen prior to the appointment.

17. The apparatus of claim 12, further comprising
causing, by the computing device, a display of wait time associated with the appointment.

18. The apparatus of claim 12, wherein remotely checking-in for the appointment further includes receiving instructions for remotely checking-in for the appointment from a mobile device.

19. The apparatus of claim 18, wherein remotely checking-in for the appointment further includes receiving instructions for automatically checking-in in response to automatically detecting the mobile device within a predetermined geographic area of a location associated with the appointment.

20. The apparatus of claim 12, wherein saving the audio recording of the appointment further includes automatically transcribing the audio recording.

21. The apparatus of claim 12, wherein reviewing the audio recording of the appointment further includes displaying, by the computing device, a link configured to activate playing of the audio recording.

22. The apparatus of claim 12, wherein the plurality of actions further includes modifying a profile associated with the patient, reading lab or test results for the patient, viewing a graphical display of health progress for the patient, reviewing a list of prescriptions of the patient, ordering the prescriptions of the patient, making a payment associated with the appointment, scheduling an appointment for the patient, or accessing medical forms needed by the patient to track health.

23. A memory device having instructions stored thereon that, in response to execution by a processing device, cause the processing device to perform operations comprising:
causing, by a computing device, a display of a page including a plurality of prompts corresponding to a plurality of actions associated with a patient;
receiving, by the computing device, a selection of at least one of the plurality of prompts corresponding to at least one of the plurality of actions;
causing, by the computing device, a display of an action page including a plurality of data entry fields corresponding to the at least one of the plurality of actions in response to the selection; and
receiving, by the computing device, response data to at least one of the plurality of data entry fields;
wherein the plurality of actions includes transmitting a notification that includes a wait time associated with the appointment, remotely checking-in for an appointment, saving an audio recording of the appointment, or reviewing an audio recording of the appointment.
